(19) United States
(12) Patent Application Publication
(10) Pub. No.: US 2006/0240821 A1
(43) Pub. Date: Oct. 26, 2006

(54) Identifying and automatically messaging system for a wireless communication server and operating method for the same

(76) Inventor: Huan-Wen Chien, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/113,150

(22) Filed: Apr. 25, 2005

(51) Int. Cl. H04M 1/68; H04M 1/66; H04M 3/16; H04Q 7/20

(52) U.S. Cl. 455/433; 455/432.1

(57) ABSTRACT

An identifying and automatically messaging system for a wireless communication server and an operating method for the same is disclosed. A mobile phone having a wireless communication module of the preferred embodiment brings the representative of the owner in different occasion by employing the identifying and messaging system. Whereby, the mentioned mobile phone can represent for its owner by utilizing an ID code built in the wireless communication module of the same. Furthermore, the identifying and messaging system of the present invention adopted in the mobile phone can demonstrate or notify the owner's identification through the wireless communication. In addition, the wireless communication module of the mobile phone can be used to announce or refresh the information therein, or even to do the function adjustment.

### BACKGROUND OF THE INVENTION

1. Field of the Invention

The present invention relates to an identifying and automatically messaging system for a wireless communication server and an operating method for the same, and particularly relates to a system for identifying and automatically sending message or updating information to a wireless communication device, and further a method therefor is disclosed.

2. Description of Related Art

In the IT era, mobile phones have become universal communication tools, most people always carry their mobile phones everywhere such as in an office, at home, traveling or shopping, so their phones are almost as a means of representing or identifying themselves. For example, in South Korea people can use their mobile phones to perform margin trading, but this application can't completely bring the characteristic about the mobile phone is as a means of representing or identifying user self. Another, as mobile phones develop quickly, their functions have also increased. Many mobile phones now for example, are cameras, voice recorders, MP3 players, and PDAs all built into a unit. However, mobile phones generate much interference due to their omnipresence. For example, people may be disrupted by the ringing of a mobile phone while working in an office, watching a movie or enjoying a concert. So the mobile phone is conveniently used in the lift, but it is bringing additional interference.

### SUMMARY OF THE INVENTION

In one aspect of the present invention, the present invention provides an identifying and automatically messaging system for a wireless communication server, comprising at least one wireless communication module, a database, and a processor device. The database stores identification data, guiding messages corresponding to the identification data and transmitting objects of the guiding messages. The processor device is electrically connected to the wireless communication module and the database, identifies a wireless communication device through the wireless communication module for find the corresponding identification data stored in the database and then transmits information the corresponding guiding message to the transmitting object.

In another aspect of the present invention, the present invention provides the operating method of the wireless communication server system for identifying a wireless communication device. The method comprises the following steps: detecting the wireless communication device; receiving identifying information from the wireless communication device; determining whether a database of the wireless communication server system has an identification data in correspondence with the identifying information or not; and if yes, executing a predetermined instruction corresponding to the identification data.

In further aspect of the present invention, the present invention provides the operating method of the wireless communication server system for automatically sending message to a wireless communication device. The method comprises the following steps: detecting a wireless communication device in a requisite entrance for entering a space; determining whether a configuration mode of the wireless communication device is a predetermined mode or not; if no, automatically sending a predetermined notice message to the wireless communication device, wherein the predetermined notice message comprises a different information between the configuration mode and the predetermined mode; determining whether the configuration mode of the wireless communication device is the predetermined mode at an predetermined interval time; and if no, automatically resending the predetermined notice message to the wireless communication device.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a wireless communication server system according to the present invention;

FIG. 2 is a flowchart of an operating method of a wireless communication server system for identifying a wireless communication device; and

FIG. 3 is a flowchart of an operating method of a wireless communication server system for automatically sending message to a wireless communication device.

### DETAILED DESCRIPTION OF THE EMBODIMENTS

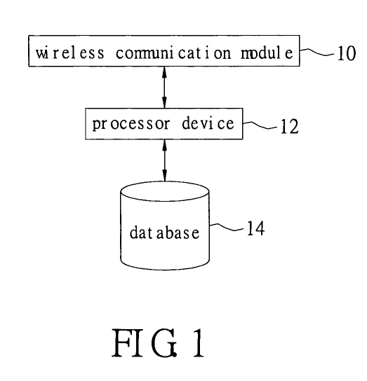

FIG. 1 is a block diagram of an identifying and automatically messaging system for a wireless communication server according to the present invention. The wireless communication server system includes at least one wireless communication module 10, a processor device 12 and a database 14. The wireless communication module 10 is electrically connected to the processor device 12. The wireless communication module 10 can connect various kinds of wireless communication devices, thereby to receive and transmit data therebetween.

The database 14 is electrically connected to the processor device 12. The database 14 stores identification data, guiding messages corresponding to the identification data and transmitting objects of the guiding messages. The processor device 12 can detect and connect to the wireless communication devices through the wireless communication module 10. Namely, the processor device 12 searches nearby wireless communication devices (such as, mobile phone, etc.), receive identifying information (such as, ID data, for example: bluetooth address, Media Access Control Address (MAC) of Wi-Fi, SIM data, IMEI code of the mobile phone, bluetooth friendly name, phone number, company name, position, ID number, V-card, business card, user name or the combination thereof) from the wireless communication device, and then compares the identifying information with identification data stored in the database 14, thereby to confirm the user's identification data and transmitting a message corresponding to the identification data to a transmitting object.

The wireless communication server system can be applied to a region where users must pass to enter a place, so that the wireless communication server system can identify whether the users will enter the region. For example, the wireless communication server system can detect signal intensity from a device with the wireless communication module, and determine that the owner of the device will enter the region when the signal intensity increases to a predetermined value; or the wireless communication module of the wireless communication server system detects directionally to an entranceway of the region, so that the system can confirm that the user is entering the region by detecting his wireless communication device.

The wireless communication server system of the present invention is introduced to a general company. Firstly, the wireless communication server system is installed in a necessary passage (such as, doorway) of the company for detecting staff carrying a wireless communication device to enter the company, and the wireless communication server system immediately records the staff's entry time, so the staff must not clock in. Furthermore, if the company has announcements, messages, update data for all staff or just specific staff, the system will detect whether the announcements, the messages or the data of the wireless communication device of the staff is the latest; if no, the system transmits the messages/data to the wireless communication device. For examples, the messages/data transmitted to the staff comprises clock-in/clock-out time of the staff, new calendar data, new or updated client or colleague's data, phone book information, business card data, program, announcement messages and so on. Therefore, any new information can be transmitted to the staff through the wireless communication server system, and new colleague data, new client and other colleague information can also be automatically updated to the wireless communication device of the staff through the wireless communication server system. The wireless communication server system can be connected to the internal network of the company or the Internet to update or revise the database for updating data stored on the wireless communication devices of the staff. The wireless communication server system further notify the staffs with the latest messages by connecting to telecoms operator to send out a short message (for example: because X typhoon will come, tomorrow is on holiday, please don't go out for safety. HR department truly yours) or another transmission method Furthermore, the staff can record the client's data and/or greeting manner to the database in advance when the client will visit the staff. When the wireless communication server system detects the client that arrives to the company, the wireless communication system will inform the client via sound or image of the greeting information. For example, the greeting information, such as “Welcome Mr. X of Y Company, please sit in the Z seat, and Mr. A will soon be with you.” The process device can adjust a seat depending upon which seat is available, and the wireless communication server system can communicate words, pictures, images for guiding the client to the seat by MMS, a screen on the greeting place or voice method and so on. The server system immediately informs the visited staff that the client is seating in the Z seat by SMS, E-mail method and so on of the wireless communication device. With regard to the client provisionally arriving, if the database has been have the data of the visited client, the server system can also inform the appropriate member of staff or director to greet the client. If the database doesn't have the client's data stored therein, the server system will inform the client to return his identification information via a voice or an image method (for example: welcome to the company, please reserving your identification data). After the client has transmitted his identification data via their mobile phone or inputted his identification data via an input device of the computer and so on, the wireless communication server system can inform the appropriate member of staff or director according to the client's identification data for receiving him, and the wireless communication server system will store the identification data in the database. Accordingly, when the client revisits, the system will be able to make an appropriately arrangement due to the client's information that has stored in the database.

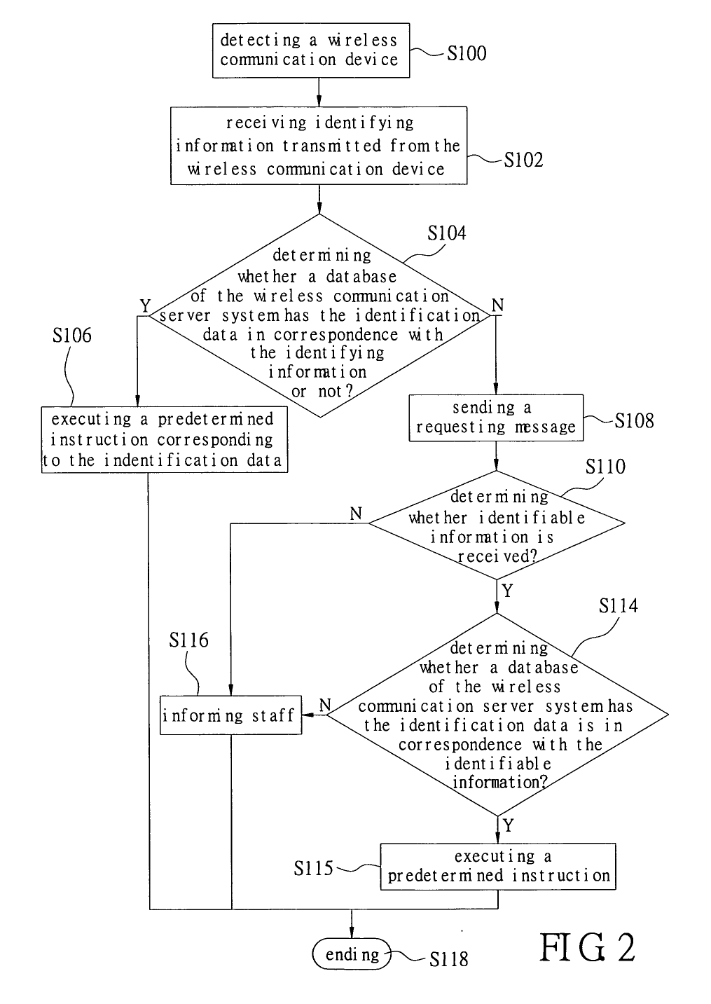

As previously stated, FIG. 2 is a flowchart of a method of operating a wireless communication server system for identifying a wireless communication device.

The method includes the following steps:

First, the identifying and automatically messaging system for a wireless communication server detects a certain wireless communication device around (S100), and the target wireless communication device sends an identifying information as receiving the detection signal from the server. (S102). Then the server determines whether the built-in database of the wireless communication server has the identification data in correspondence with the identifying information or not (S104). If the identification data corresponds to a certain data in the database, a predetermined instruction corresponding to the identification data is executed (S106), and ends the execution (S118).

In step (S104), if the database doesn't have identification data in correspondence with the identifying information, and the server sends a requesting message (S108) for requesting the wireless communication device to return an identifiable information (such as a phone number, a company name, a position, a user name, an ID number, a V-card or a TraCQ), and the server determines whether the identifiable information is received or not (S110). If the server receives the returned identifiable information, then determines whether the database of the wireless communication server has the identification data in correspondence with the identifiable information (S114). If the identifiable information corresponds to a certain data in the database, the identifying and automatically messaging system will execute the predetermined instruction (S115). The aforementioned predetermined instruction can be a predetermined message, such as one or a combination of an SMS message, pictures, sounds or images and a program, to one or a combination of a predetermined member of staff and the wireless communication device through Internet, telecom network, or wireless communication. If the database doesn't have the identification data is in correspondence with the identifiable information, the staff will be informed to deal with (S116). The aforementioned identification information and the corresponding predetermined instruction can be stored in the database by an operator in advance.

The following is another example for a movie theater (or a library, or performance theater) utilizing the method of operating the present invention. The wireless communication module of the wireless communication server system is installed in the movie theater entrance for detecting whether a customer has entered to the movie theater. When the customer has entered the movie theater, the wireless communication system will detect a configuration mode of a user's wireless communication device, and then determining whether the configuration mode is set to be in correspondence with a predetermined mode (e.g. silent mode or vibrating mode). If no, the wireless communication server system will be able to automatically send a predetermined message to the wireless communication device, such as “In the movie theater, please turn off your mobile phone (or set it to silent mode or vibrating mode) for the duration of this performance.” When parts of the configuration mode are differenced to the predetermined mode, the wireless communication server system will only transmit a reminder message according to the different set parts to the wireless communication device.

Next, the wireless communication server system detects the configuration mode of the wireless communication device at predetermined interval time, and then if the configuration mode is not set in the predetermined mode, it will automatically send the predetermined message to the wireless communication device again until the desired mode has been set. If the wireless communication device is installed with an automatic executed program or an automatic installed program to change configuration mode or function, the wireless communication server system can transmit an executing command message to make the wireless communication device automatically change the configuration mode, or the wireless communication server system can transmit the automatic executing program for the wireless communication device installs, and transmit the executing command message for the wireless communication automatically changing the configuration mode.

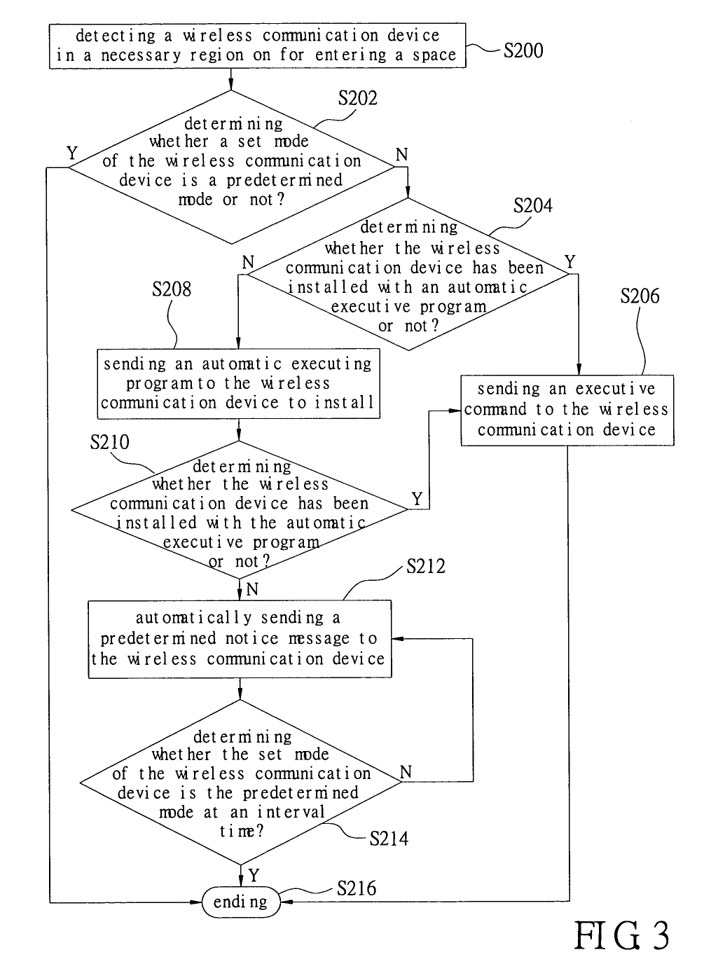

The wireless communication server of the present invention can send a message to other wireless communication devices, wherein that the message can be a function executing command. Referring to FIG. 3, this method includes the following the steps: determining whether the wireless communication device has been installed with the automatic executing program, and if yes, sending a command message to make the mobile phone change its configuration mode, for example, disabling the camera function, recording function or changing the phone's configuration mode to silent mode or vibrate mode. However, if the wireless communication device doesn't install an automatic executing program, the wireless communication server system will send an asking message to ask whether the user's wireless communication device allows installing the automatic executing program. If the user allows his wireless communication device installing the automatic executing program, the commend message will be sent for the wireless communication device change the configuration mode to the predetermined mode after the program has been transmitted and installed to the wireless communication device. If the user does not allow installing the automatic executing program on their wireless communication device, or if their wireless communication device does not support the installed automatic executing program function, a predetermined message will be repeatedly sent to the wireless communication device until such a time as the users change the configuration mode of their wireless communication device, or switch them off, by themselves.

FIG. 3 is a flowchart of a method of operating a wireless communication server system for automatically sending a message to a wireless communication device.

The operating method for the identifying and automatically messaging system includes the following steps:

The system detects a wireless communication device in a requisite entrance (S200), and determines whether a configuration mode of the wireless communication device is a predetermined mode or not (S202). If the device stays in the predetermined mode, the system ends the detection (S216). If the device doesn't stay in the predetermined mode, the system determines whether the wireless communication device has been installed with an automatic executive program or not (S204). If the device has been installed the program, the server sends an executive command to the wireless communication device (S206). If the device hasn't been installed the program, the server sends an automatic executing program to the wireless communication device, and requires the device to install the program (S208).

The aforementioned detecting and determining steps are repeatedly processed to confirm the wireless communication device has the automatic executive program. Such as, the server determines whether the wireless communication device has been installed with the automatic executive program or not (S210). If the device has been installed the program already, the step goes back to Step (S206). If the device has no the program installed, the server automatically sends a predetermined notice message to the wireless communication device (S212), wherein the predetermined notice message has an information of different set parts between the configuration mode and the predetermined mode. The server periodically determines whether the configuration mode of the wireless communication device is the predetermined mode (S214), if the device stays in the predetermined mode, the server ends the determination, if the device doesn't stay in the predetermined mode, the step goes back to Step (S212).

To sum up, the operating method of the wireless communication server system capable of identifying and automatically sending a message for a wireless communication device according to the present invention has the following characteristics:

1. The system provides to identify information of a wireless communication device at any time; and

2. The system can transmit announcements, information, update data, and inform or immediately adjust the configuration mode of a wireless communication device.

The detecting and transmitting method can also use any wireless communication module to receive or transmit data, and supporting any wireless communication device's operating system to achieve the functions and described above.

What is claimed is:

1. An operating method for identifying and automatically messaging system, comprising steps of:
detecting a wireless communication device;
receiving an identifying information from the wireless communication device;
determining whether a database of a wireless communication server has an identification data in correspondence with the identifying information or not;
and if yes, executing a predetermined instruction corresponding to the identification data.

2. The method of claim 1, further comprising a step of:
receiving the identification data and a corresponding predetermined instruction, and then being built in the database.

3. The method of claim 2, wherein the step for detecting is to detect in a certain field having a directional feature.

4. The method of claim 2, wherein the determining step further comprises:
if the database does not have the identification data in correspondence with the identifying information, and then the wireless communication server sends a requesting message for requesting the wireless communication device to return an identifiable information.

5. The operating method of claim 4, further comprising a step of:
determining whether the identifiable information is received or not, and if yes, determining whether a database of the wireless communication server system has the identification data in correspondence with the identifiable information or not, and if yes, executing the predetermined instruction.

6. The operating method of claim 2, wherein the identification data is one or a combination of an identification number, a phone number, a company name, a position, name, a ID number, a V-card and a business card of a wireless communication device.

7. The operating method of claim 2, wherein the predetermined instruction is to transmit a message to one or a combination of a member of staff and the wireless communication device.

8. The operating method of claim 7, wherein the message is transmitted through one or a combination of a network, a telecommunication network and a wireless communication.

9. The operating method of claim 8, wherein the message is one or a combination of a word, a figure, a sound, an image and a program.

10. An operating method for identifying and automatically messaging system, comprising steps of:
detecting a wireless communication device in a requisite entrance for entering a space;
determining whether a configuration mode of the wireless communication device is a predetermined mode or not; if no, automatically sending a predetermined notice message to the wireless communication device, wherein the predetermined notice message comprises an information of different set parts between the configuration mode and the predetermined mode;
determining whether the configuration mode of the wireless communication device is the predetermined mode in a predetermined time; and if no, automatically resending the predetermined notice message to the wireless communication device.

11. The method of claim 10, further comprising a step of:
determining whether the wireless communication device is installed with an automatic executive program or not; and if yes, sending an executive command to the wireless communication device.

12. The method of claim 11, wherein the executive command is to change the configuration mode of the wireless communication device to the predetermined mode.

13. The method of claim 11, further comprising a step of:
if the wireless communication device is not installed with an automatic executive program, an automatic executive program is sent to the wireless communication device so as to be installed.

14. A wireless communication server system, comprising:
at least one wireless communication module;
a database storing at least one identification data, one guiding message corresponding to the identification data and at least one transmitting object of the guiding messages; and
a processor device electrically connected to the wireless communication module and the database, identifying a wireless communication device through the wireless communication module for finding the corresponding identification data stored in the database and then transmitting the corresponding guiding message to the transmitting object.

15. The wireless communication server system of claim 14, wherein the identification data is one or a combination of an identification number, a phone number, a company name, a position, a name, a ID number, a V-card and a business card.

16. The wireless communication server system of claim 14, wherein the guiding message is transmitted through one or a combination of a network, a telecommunication network and a wireless communication.

17. The wireless communication server system of claim 14, wherein the guiding message is one or a combination of a word, a figure, a sound, an image and a program.

18. The wireless communication server system of claim 14, wherein the processor device stores information of detecting time and the identification data of the wireless communication device in the database.

19. The wireless communication server system of claim 14, wherein the processor device determines whether data of the wireless communication device is the latest and transmits an updated data of the database to the wireless communication device.

20. The wireless communication server system of claim 19, wherein the updated data is one or a combination of new calendar data, phone book information, business card data, a program and an announcement message.
